(19) United States
(12) Patent Application Publication
(10) Pub. No.: US 2007/0219768 A1
(43) Pub. Date: Sep. 20, 2007

(54) System and method for prediction of drug metabolism, toxicity, mode of action, and side effects of novel small molecule compounds

(76) Inventors: Sean Ekins, Jenkintown, PA (US); Andrej Bugrim, St. Joseph, MI (US); Tatiana Nikolskaya, Portage, IN (US); Yuri Nikolsky, Portage, IN (US)

Correspondence Address: David B. Waller, Suite 214, 5677 Oberlin Drive, San Diego, CA, 92121, US

(21) Appl. No.: 11/378,928

(22) Filed: Mar. 17, 2006

(51) Int. Cl. G06G 7/48; G06G 7/58

(52) U.S. Cl. 703/11

(57) ABSTRACT

A system is provided for the prediction of human drug metabolism and toxicity of novel compounds. The system enables the visualization of pre-clinical and clinical high-throughput data in the context of a complete biological organism. Substructure and similarity structure searches can be performed using the underlying databases of xenobiotics, active ligands, and endobiotics. The system also has an analytical component for the parsing, integration, and network analysis of genomics, proteomics, and metabolomics high-throughput data. From this information, the system further generates networks around proteins, genes and compounds to assess toxicity and drug-drug interactions.

### RELATED APPLICATION

This application claims priority under U.S.C. §119(e) to U.S. Provisional Patent Application No. TBD filed on Mar. 17, 2005, by Nikolskaya et al., entitled “SYSTEM AND METHOD FOR PREDICTION OF DRUG METABOLISM AND TOXICITY OF NOVEL SMALL MOLECULE COMPOUNDS”.

### FIELD OF THE INVENTION

The present invention relates to systems for the prediction of drug metabolism and the toxicity of novel compounds.

### DESCRIPTION OF THE RELATED ART

Cellular life can be represented and studied as the “interactome,” the dynamic network of biochemical reactions and signaling interactions between active proteins. A systemic network analysis is optimal for the integration and functional interpretation of high-throughput experimental data that are abundant in drug discovery yet poorly understood. The composition and topology of these complex networks are closely associated with vital cellular functions, which have important implications for life science research. Network theory development has advanced alongside the curation of reliable databases of protein interactions for human and model organisms that require comprehensive analytical tools.

The existing drug discovery and analysis systems can be classified into two categories. The first type of system analyzes high throughput (HT) data, which over the last several years has resulted in a paradigm shift for life science research due to the unprecedented scale-up of several laboratory techniques. These include automated DNA sequencing, global gene expression measurements, and proteomics and metabonomics techniques. High throughput data provides information on gene expression, protein interactions, and small molecule metabolism such that such data are ubiquitous throughout the drug discovery pipeline from target identification and validation to the development and testing of drug candidates to clinical trials.

Software such as MetaCore™ (GeneGo, Inc., St. Joseph, Mich.), PathArt and PathwayAssist (Ariadne Genomics, Inc., Rockville, Md.), and Pathways Analysis (Ingenuity Systems, Mountain View, Calif.) can be used to analyze such HT data in association with gene expression and protein pathways. These software programs can be used to predict and model which protein pathways may be affected by a small molecule. The information on protein interactions is collected from the published experimental data that is then annotated and assembled into databases on the interactions. The network data analysis software that is now commercially available is robust enough for simultaneous processing of many large data files containing thousands of data points such as whole-genome expression microarrays.

The second category of drug discovery systems has existed since the 1970s. At that time, industry and academia organized databases on proteins, enzyme-encoding genes, and metabolic and cell signaling pathways, that represented a starting point for systemic absorption, distribution, metabolism, elimination, and toxicology (ADME/Tox) studies. There have been limited efforts to organize ADME/Tox data, although separate focused databases of ADME associated proteins or pathways such as PharmaGKB, a nuclear receptor database, a human membrane transporter database and other databases could theoretically be integrated. Newer commercial drug metabolism databases, such as Metabolite (MDL Information Systems, San Leandro, Calif.), Metabolism (Accelrys, Inc., San Diego, Calif.), and BioFrontier/P450 (FQS Poland), represent a broad collection of metabolic data. These databases are useful for calculating probabilities for a metabolic reaction, predicting metabolites, or predicting the sites of metabolism using a statistical approach.

Similarly, the accumulation of drug metabolism data from the literature has also resulted in the creation of expert systems for metabolism prediction for esters, O- and N-alkyl derivatives, and aromatic fragments. This has resulted in commercial rule-based products such as MetabolExpert (CompuDrug International, Inc., Sedona, Ariz.), META (MultiCase Inc., Cleveland, Ohio), and METEOR (Llasa Ltd., Leeds, United Kingdom).

The application of quantitative structure activity [or metabolism] relationships (QSA[M]R) has been widely applied by Hansch and co-workers with generally small homologous sets of molecules. These programs require the generation of molecular descriptors which are then related to experimental data to result in an equation using one or more of many algorithm technologies. A new molecule would then have these descriptors generated to ultimately predict a value from the model. Based upon rules written into the software, a molecule is then predicted to be either biologically active as intended or not.

Early efforts divided metabolic transformations into three composite processes: binding to an enzyme, chemical modification, and release of a metabolite. In time, the properties found to be important to determine enzyme binding and transformation included lipophilicity, steric, electronic, and molecular shape properties with metabolite release likely requiring the opposite properties to binding.

There is a present and recurring need for improved drug discovery systems that allow easy input of molecular structure and/or properties, provide an intuitive interface with the user, and perform comprehensive and modifiable analysis of metabolite generation through use of comprehensive databases and metabolic and QSAR models. Such a drug discovery system is desired to provide more accurate and precise prediction of the interaction between xenobiotics and biological organisms.

### SUMMARY OF THE INVENTION

One aspect of the invention is a system for predicting the interaction between a chemical compound and a biological organism, the system comprising: a first means for predicting one or more first level metabolites of the chemical compound in the biological organism; a second means for predicting the interaction of the chemical compound and the first level metabolites with the biological organism; and a means for visualizing the interaction of the chemical compound, the first level metabolites, and the biological organism. According to an embodiment of the invention, the biological organism is a human being.

According to another embodiment of the invention, the biological organism is modeled using one or more types of biological compounds. The one or more types of biological compounds is comprised of one or more of the group composed of proteins, nucleic acids, or organic compounds. The group of proteins is comprised of one or more of the group composed of enzymes, prions, and peptides. The group of nucleic acids is comprised of one or more of the group composed of DNA, RNA, genes, and chromosomes.

According to an embodiment of the invention, the system further comprises a third means for predicting one or more higher-level metabolites of the one or more first level metabolites. The method for the third means of prediction is the same as the method for the first means of prediction. According to an embodiment of the invention, the system further comprises means for choosing the one or more predicted first level or higher-level metabolites to predict the interactions of the chemical compound in the biological organism.

According to an embodiment of the invention, the system further comprises means for inputting one of the chemical compound name, structure, or data. As a further embodiment of the invention, the system comprises a fourth means for prediction of the likelihood of the one or more predicted first level or higher-level metabolites to occur in the biological organism.

According to an embodiment of the invention, the system comprises means for analyzing high-throughput data. The system may further comprise means for generating one or more biological pathways from the high-throughput data.

According to an embodiment of the invention, a system comprises databases comprising of at least one or more of the group composed of xenobiotics, endobiotics, ligands, drugs, drug interactions, drug binding data, biological pathways, genes, proteins, and disease links to genes.

According to an embodiment of the invention, a system further comprises means for comparing predicted interactions of at least one of the chemical compound, first level metabolites and higher-level metabolites in the biological organism with the biological pathways generated from the high-throughput data. A system may further predict the interaction of at least one of the chemical compound, first level metabolites, and higher-level metabolites with the biological organism is advantageous. Additionally, a system may predict the advantageous interaction that a chemical compound can be used as a drug in the biological organism.

According to an embodiment of the invention, a system predicts the interaction is disadvantageous in the biological organism of at least one of the chemical compound, first level metabolites, and higher-level metabolites. A system may further predict whether the disadvantageous interaction of a chemical compound is toxic or has side or deleterious effects in the biological organism.

According to an embodiment of the invention, a system predicts the one or more first level or higher-level metabolites of the chemical compound using predetermined rules, QSAR models, or other algorithms. According to another embodiment of the invention, a system user may choose the predetermined rules, QSAR models, or other algorithms to predict the one or more first level or higher-level metabolites of the chemical compound.

Another aspect of the invention is a method for predicting the interaction between a chemical compound and a biological organism, the system comprising: a first step for predicting one or more first level metabolites of the chemical compound in the biological organism; a second step for predicting the interaction of the chemical compound and the first level metabolites with the biological organism; and a third step for visualizing the interaction of the chemical compound, the first level metabolites, and the biological organism. According to an embodiment of the invention, the biological organism is a human being.

According to another embodiment of the invention, the biological organism is modeled using one or more types of biological compounds. The one or more types of biological compounds is comprised of one or more of the group composed of proteins, nucleic acids, or organic compounds. The group of proteins is comprised of one or more of the group composed of enzymes, prions, and peptides. The group of nucleic acids is comprised of one or more of the group composed of DNA, RNA, genes, and chromosomes.

According to an embodiment of the invention, the method further comprises a fourth step for predicting one or more higher-level metabolites of the one or more first level metabolites. The method for the means of prediction used for the fourth step may be the same means of prediction as needed for the first step. According to an embodiment of the invention, the method further comprises a step for choosing the one or more predicted first level or higher-level metabolites to predict the interactions of the chemical compound in the biological organism.

According to an embodiment of the invention, the method further comprises a step for inputting one of the chemical compound name, structure, or data. As a further embodiment of the invention, the method comprises another step for prediction of the likelihood of the one or more predicted first level or higher-level metabolites to occur in the biological organism.

According to an embodiment of the invention, the method comprises a step for analyzing high-throughput data. The method may further comprise a step(s) for generating one or more biological pathways from the high-throughput data.

According to an embodiment of the invention, a method comprises databases comprising of at least one or more of the group composed of xenobiotics, endobiotics, ligands, drugs, drug interactions, drug binding data, biological pathways, genes, proteins, and disease links to genes.

According to an embodiment of the invention, a method further comprises a step(s) for comparing predicted interactions of at least one of the chemical compound, first level metabolites and higher-level metabolites in the biological organism with the biological pathways generated from the high-throughput data. A method may have additional step(s) to further predict the interaction of at least one of the chemical compound, first level metabolites, and higher-level metabolites with the biological organism is advantageous. Additionally, a method may predict the advantageous interaction that a chemical compound can be used as a drug in the biological organism.

According to an embodiment of the invention, a method may have a step(s) to predicts the interaction of at least one of the chemical compound, first level metabolites, and higher-level metabolites with the biological organism is disadvantageous. A method may have an additional step(s) that may further predict whether the disadvantageous interaction of a chemical compound is toxic or has side or deleterious effects in the biological organism.

According to an embodiment of the invention, a method predicts the one or more first level or higher-level metabolites of the chemical compound using predetermined rules, QSAR models, or other algorithms. According to another embodiment of the invention, a system user may choose the predetermined rules, QSAR models, or other algorithms to predict the one or more first level or higher-level metabolites of the chemical compound.

Another aspect of the invention is a computer means for predicting the interaction between a chemical compound and a biological organism, the computer means comprising: a first means for predicting one or more first level metabolites of the chemical compound in the biological organism; a second means for predicting the interaction of the chemical compound and the first level metabolites with the biological organism; and a means for visualizing the interaction of the chemical compound, the first level metabolites, and the biological organism. According to an embodiment of the invention, the biological organism is a human being.

According to another embodiment of the invention, the biological organism is modeled using one or more types of biological compounds. The one or more types of biological compounds is comprised of one or more of the group composed of proteins, nucleic acids, or organic compounds. The group of proteins is comprised of one or more of the group composed of enzymes, prions, and peptides. The group of nucleic acids is comprised of one or more of the group composed of DNA, RNA, genes, and chromosomes.

According to an embodiment of the invention, the computer means further comprises a third means for predicting one or more higher-level metabolites of the one or more first level metabolites. The computer means for the third means of prediction is the same as the method for the first means of prediction. According to an embodiment of the invention, the computer means further comprises means for choosing the one or more predicted first level or higher-level metabolites to predict the interactions of the chemical compound in the biological organism.

According to an embodiment of the invention, the computer means further comprises means for inputting one of the chemical compound name, structure, or data. As a further embodiment of the invention, the computer means comprises a fourth means for prediction of the likelihood of the one or more predicted first level or higher-level metabolites to occur in the biological organism.

According to an embodiment of the invention, the computer means comprises means for analyzing high-throughput data. The computer means may further comprise means for generating one or more biological pathways from the high-throughput data.

According to an embodiment of the invention, a computer means comprises databases comprising of at least one or more of the group composed of xenobiotics, endobiotics, ligands, drugs, drug interactions, drug binding data, biological pathways, genes, proteins, and disease links to genes.

According to an embodiment of the invention, a computer means further comprises means for comparing predicted interactions of at least one of the chemical compound, first level metabolites and higher-level metabolites in the biological organism with the biological pathways generated from the high-throughput data. A computer means may further predict the interaction of at least one of the chemical compound, first level metabolites, and higher-level metabolites with the biological organism is advantageous. Additionally, a computer means may predict the advantageous interaction that a chemical compound can be used as a drug in the biological organism.

According to an embodiment of the invention, a computer means predicts the interaction of at least one of the chemical compound, first level metabolites, and higher-level metabolites with the biological organism is disadvantageous. A computer means may further predict whether the disadvantageous interaction of a chemical compound is toxic or has side or deleterious effects in the biological organism.

According to an embodiment of the invention, a computer means predicts the one or more first level or higher-level metabolites of the chemical compound using predetermined rules, QSAR models, or other algorithms. According to another embodiment of the invention, a user may choose the predetermined rules, QSAR models, or other algorithms to predict the one or more first level or higher-level metabolites of the chemical compound.

Further features and advantages of the present invention as well as the structure of various embodiments of the present invention will be more fully understood from the examples described below with reference to the accompanying drawings. The following examples are intended to illustrate the benefits of the present invention, but do not exemplify the full scope of the invention. All references cited herein are expressly incorporated by reference.

### BRIEF DESCRIPTION OF THE DRAWINGS

FIG. 1 is a representation of a computer program according to embodiments of the invention;

FIG. 2 is a diagram showing a high-level flow chart of a process for identifying promising drug compounds according to embodiments of the invention;

FIG. 3 is a representation of a legend for metabolic map according to embodiments of the invention;

FIG. 4 is a representation of a thiamine metabolism map according to embodiments of the invention;

FIG. 5 is a block diagram of a general-purpose computer system upon which various embodiments of the invention may be implemented;

FIG. 6 is a block diagram of a computer data storage system with which various embodiments of the invention may be practiced;

FIG. 7 is a diagram showing a high-level flow chart of a process for predicting side effects that may be caused by a compound;

FIG. 8 is a representation of a microarray network that confirms Iressa inhibits EGRF;

FIG. 9 is a diagram showing a high-level flow chart of a process for screening of analysis data;

FIG. 10 is a more detailed flow chart of a process for identifying promising drug compounds as shown in FIG. 2 and according to embodiments of the invention; and

FIG. 11 is a representation of the information in a cell and the data generated at each level.

### DETAILED DESCRIPTION OF THE INVENTION

Existing drug discovery systems may be categorized into distinct groups. The first group utilizes and analyzes HT data, which elucidates chemical interactions in the body, including protein pathways and gene expression. The difficulty with using this type of software is the upfront biological testing that must be performed to obtain the massive quantities of data to allow a predictive capability with other molecules. HT data is usually generated for one pathway at a time and therefore the interaction of the pathways is also often lacking. This type of software may be considered to be based largely upon biochemical data generated by studying one biochemical pathway at a time.

A second type of approach is a rule-based system that uses a knowledge base of molecules with known information such as metabolism, binding etc. In this case the similarity of a new molecule to one that exists in the database can be used as a method to suggest similar metabolism of activity at a biological target. A third type of drug discovery systems that uses chemical interaction rules or QSAR methodology can be used to predict the metabolism of xenobiotic compounds in the body as well as affinity for other proteins such as enzymes, transporters, channels and receptors. This type of approach looks at a biological organism as a chemical system with distinct and unconnected chemical reactions.

As used here, a biological organism is defined as a living organism, such as a plant, insect, or mammal. Preferably, the biological organism of the invention is a human being. Alternatively, a biological organism may be a subsystem of a living being, e.g. the citric acid cycle or the lymphatic system; the subsystem of interest for study using the drug discovery system may be defined by the system user.

In general, databases and expert systems that contain combined data or rules from many different mammalian species may be less useful for predicting human metabolism alone. Ideally the data and rules for each species should be separate. Consequently, the programs using this information in combined databases tend to predict all the metabolic possibilities for an exogenous molecule, essentially creating an ‘average’ mammal that may be dissimilar to the human situation. The metabolic pathways and corresponding networks can be very different even in close mammalian species. Metabolism of the same drug may further vary substantially between individuals depending on the expression level of particular enzymes, polymorphisms in enzyme-encoding and regulatory genes and the presence of particular enzymes in normal and disease states as well as different tissues.

Effective drug discovery systems for the complexity of biological organisms require a system-wide approach to data analysis, which can be defined as the integration of “OMICs” data with computational methods or chemical modeling. A system-wide approach uses the relationships of all elements rather than approaching them separately. This approach can be taken from the “top down” (using a conceptual framework to integrate data) or from the “bottom up” (combining individually modeled biochemical processes). A system-wide approach states that the identification of the “parts list” of all the genes and proteins is insufficient to understand the whole. Rather, it is the assembly of these parts (the general schema, the modules, and elements) and the dynamics of changes in response to stimuli that is truly the key to understanding a biological organism. The assembly of “cellular machinery” can be called the “interactome”, the network of interconnected signaling, regulatory, and biochemical networks with proteins as the nodes and physical protein-protein interactions as the edges.

Interpreting ADME/Tox and particularly drug metabolism using a system-wide approach may improve understanding and ultimately predictions associated with a biological organism. The perturbing effect of a molecule on the complete biological organism can be observed either experimentally (using high-throughput screening against many proteins) or theoretically (using many computational models) and across all metabolic and signaling pathways. In this way an understanding of the effects of binding to multiple proteins simultaneously can be provided. The iterative approach based on multiple cycles of data generation and modeling can also create dynamic hypotheses which are advantageous compared with purely static models. This approach also requires the collection of high-throughput and high content screening data, including global gene expression, protein content, and metabolic profiles for the same samples as well as individual genetic, clinical, and phenotypic data.

Considerable quantities of empirical ADME/Tox data have been generated and used for computational model building to score large numbers of virtual molecules against individual properties. These predictions require multi-dimensional analysis alongside target affinity and represent a means to improve lead selection efficiency.

According to one aspect of the invention, systems for predicting the effect of a molecule on a biological organism predicts the interaction of the molecule with the interactome using basic rules, QSAR modeling, or analysis of high-throughput data. Furthermore, the prediction of the system using basic rules, QSAR modeling, or analysis of high-throughput data may be improved through comparison with chemically or structurally similar xenobiotics. Information on xenobiotics may be contained within a database. The drug discovery system of the invention may be used to predict any advantageous or disadvantageous interaction of a specific molecule on a biological organism, including the effectiveness or non-effectiveness of a molecule as a drug; the effect specific molecule on a biological organism, pathway or protein; the side effects that may be expected for a specific molecule in a biological organism; or the mode of action of a specific molecule to cause a known effect in a biological organism. For this invention, the inventive system may perform any of the above functions and will be generically called a drug discovery system.

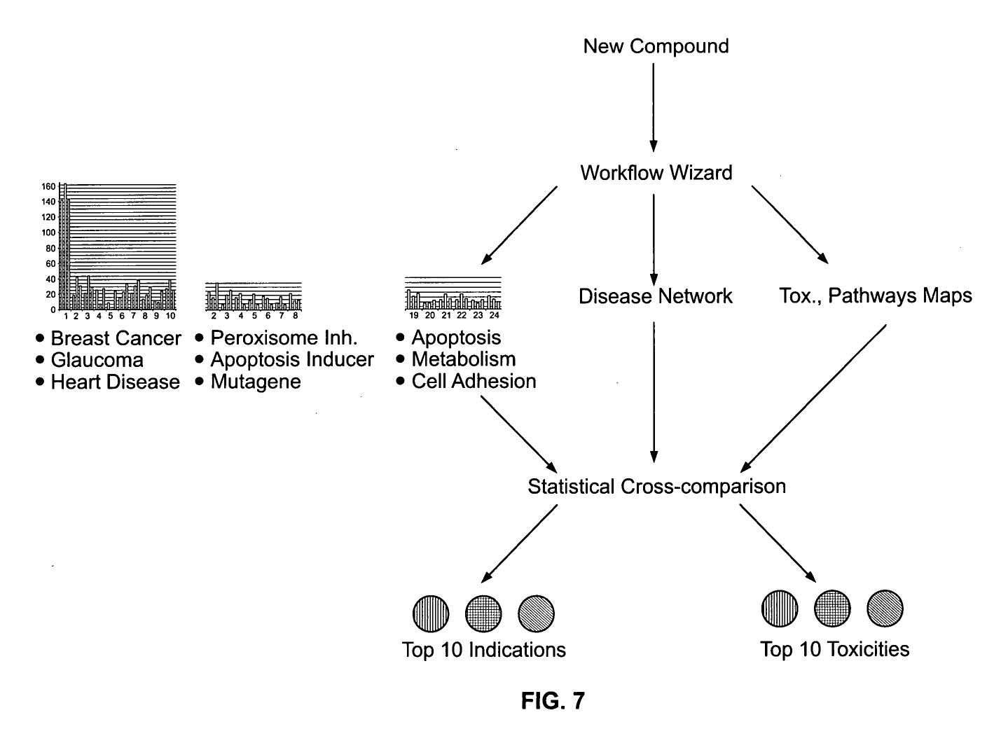

FIG. 7 is a high-level representation of a drug discovery system that predicts advantageous and disadvantageous effects of a compound. A compound and its predicted human metabolites are compared by chemical similarity and substructure search against the chemical content of a built-in database. The compounds of similar structure from the database are connected with different functional categories in the database, such as cell processes, biological networks, toxicity maps, and disease networks. P-values are then calculated for the distribution of such functional categories, and the categories are cross-referenced. Based on p-values and other statistical criteria, the highest scored potential indications (disease areas) and toxicities are calculated and then presented using simple color visualization modes.

Some of the individual steps of the drug discovery system of FIG. 7 are explained in greater detail below. FIG. 7 shows an example of a workflow path in a drug discovery system. The example is merely an illustrative embodiment of a flow path for a drug discovery system. It should be appreciated that an illustrative embodiment is not intended to limit the scope of the invention, as any of numerous other implementations of a drug discovery system, for example, variations on steps taken, are possible and are intended to fall within the scope of the invention. For a drug discovery system of the invention, additional steps may be used or one or more steps may be removed from the example. Additionally, steps may be reversed or performed in a different order. None of the claims set forth below are intended to be limited to any particular implementation of the database structure unless such claim includes a limitation explicitly reciting a particular implementation.

According to an embodiment of the invention, the metabolite(s) of the molecule of interest are also predicted. The drug discovery system may also predict the one or more metabolites of the molecule by using predetermined rules for metabolic pathways. These predicted metabolites may then be further similarly processed by the system to determine their metabolites and so on. The metabolites may then be visualized associated with the target proteins that undergo the chemical reaction within the stored biological pathways. This presents predicted metabolites in the context of the empirical data. According to another embodiment of the invention, the system may then predict the interaction of each of the predicted metabolites with the interactome.

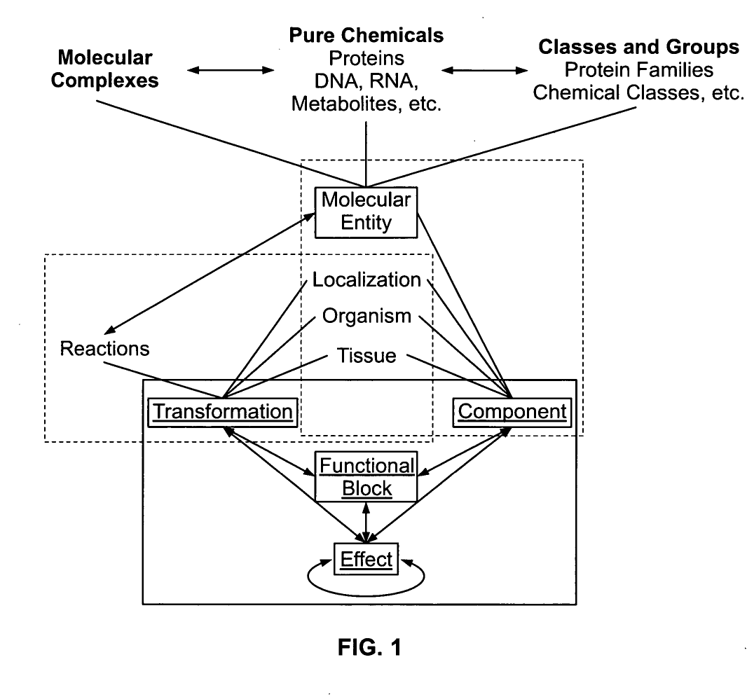

FIG. 1 represents a possible database configuration. The following example is merely an illustrative embodiment of the database structure. It should be appreciated that an illustrative embodiment is not intended to limit the scope of the invention, as any of numerous other implementations of a database structure for a drug discovery system, for example, variations of database content, are possible and are intended to fall within the scope of the invention. None of the claims set forth below are intended to be limited to any particular implementation of the database structure unless such claim includes a limitation explicitly reciting a particular implementation.

FIG. 1 shows three types of information (or elements) required for the database structure. The three types are Component, Transformation, and Effect.

Component may be defined as the functional groups of molecules in biological organisms and is related to a molecular entity, localization, cell/tissue, and organism. Thus, a Component represents biological molecules within their biological context. For this invention, the molecular entity may be treated in a broader sense than just being a specific chemical compound. In our representation, a molecular entity may also be a group of molecules (e.g. a protein family or class of chemical compounds) or a molecular complex. This is particularly useful for representing the cellular processes, when the exact chemical composition or particular isoform of a protein participating in a pathway is unknown or ambiguous.

Transformation is defined as a biochemical reaction, transport, transcription and translation, or any biological process with a primary function being to change the amount of a Component (e.g., through a reaction) that is considered in its particular environment as linked to a sub-cellular compartment, tissue, and organism. During the Transformation of a Component, one or more other molecules (i.e., metabolites) may be generated.

Effect is defined as the influence that a Component(s) exert on either a Transformation(s) or another Effect(s). Each Effect has an agent (Component) and a target (Transformation, another Effect or Functional Block). Effect is the description of biological activity, whether or not its exact mechanism is known.

The three types of elements (i.e., Components, Transformations, and Effects) may be provided as packaged databases for analysis by the drug discovery system. Such databases are well-known and are becoming increasingly more abundant. Any known and appropriate database developed for human or other biological organisms may be used. Such databases may be based upon any type of element, including databases of proteins, genes, pathway maps, xenobiotics, and interactions. Examples of databases include BIND, DIP, the Human Protein Reference Database (HPRD), MetaCore, MINT, HomoMINT, MIPS, PathArt, Pathways Analysis, BIOCarta, Gene Ontology, GenMAPP, and KEGG. Additionally, data mining packages may be utilized. The drug discovery system may use the data as provided by the databases or additional manual or automated processing is performed to further parse the data.

The summary of a database is listed in Table 1. Table 1 lists examples of known enzymes and the number of known molecules that are associated with each enzyme. An associated molecule may be an input chemical, a metabolite, an enzyme regulator, or any other molecule that has an action on or is acted upon by the enzyme. A database associated with the summary in Table 1 may also include the actual names, structure, and/or properties of the associated molecules with each enzyme.

TABLE 1
Examples of Enzymes and Number of Molecules Associated with Each Enzyme

| Enzyme | Molecules | Enzyme | Molecules | Enzyme | Molecules |
|---|---|---|---|---|---|
| CYP3A4_hum | 832 | FMO3_hum | 25 | SULT1E1_hum | 120 |
| CYP1A2_hum | 629 | FMO1_hum | 22 | SULT2A1_hum | 58 |
| CYP2D6_hum | 560 | FMO2_hum | 15 | SULT1B2_hum | 46 |
| CYP2C9_hum | 510 | FMO5_hum | 11 | SULT2B1a_hum | 44 |
| CYP2E1_hum | 441 | FMO3_hum | 25 | SULT2B1b_hum | 40 |
| CYP2C19_hum | 425 | FMO1_hum | 22 | SULT1A5_hum | 29 |
| CYP1A1_hum | 417 | FMO2_hum | 15 | SULT1A2_hum | 28 |
| CYP2A6_hum | 293 | FMO5_hum | 11 | SULT1C1_hum | 25 |
| CYP2B6_hum | 287 | GSTP1-1_hum | 41 | UGT1A1_hum | 220 |
| CYP2C8_hum | 244 | GSTM2-2_hum | 19 | UGT1A9_hum | 157 |
| CYP1B1_hum | 198 | GSTT1-1_hum | 17 | UGT2B15_hum | 150 |
| CYP19_hum | 192 | GSTA4-4_hum | 13 | UGT1A10_hum | 149 |
| CYP3A5_hum | 159 | GSTA3-3_hum | 10 | UGT1A8_hum | 149 |
| CYP2C18_hum | 84 | MAOA_hum | 71 | UGT1A3_hum | 140 |
| CYP17_hum | 63 | MAOB_hum | 61 | UGT2B7_hum | 139 |
| CYP4A11_hum | 48 | NAT1_hum | 24 | UGT1A6_hum | 136 |
| CYP2C9_hum(144R) | 44 | NAT2_hum | 22 | UGT1A4_hum | 85 |
| CYP3A7_hum | 44 | SULT1A3_hum | 165 | UGT1A7_hum | 82 |
| CYP2C9_hum(144C) | 36 | SULT1A1_hum | 127 | UGT2B17_hum | 67 |
| | | | | UGT2B4_hum | 53 |
| | | | | UGT2A1_hum | 43 |

Components, Transformations, and Effects may be grouped into Functional Blocks, which are functional units, be it a particular category of metabolism or any other functional process. Thus, Functional Blocks link together Components, Effects and Transformations that are functionally related. Functional Blocks are hierarchical as they may contain other Functional Blocks as elements. Additionally, every element may be a part of more than one block. Therefore, Functional Blocks are linked to each other by shared elements. Assembling different elements within Functional Blocks enables rapid search of functional links and function-centered analysis of expression and other high-throughput molecular data. Functional blocks may be provided by the databases providing information on the three elements but preferably are generated specifically for or by the drug discovery software.

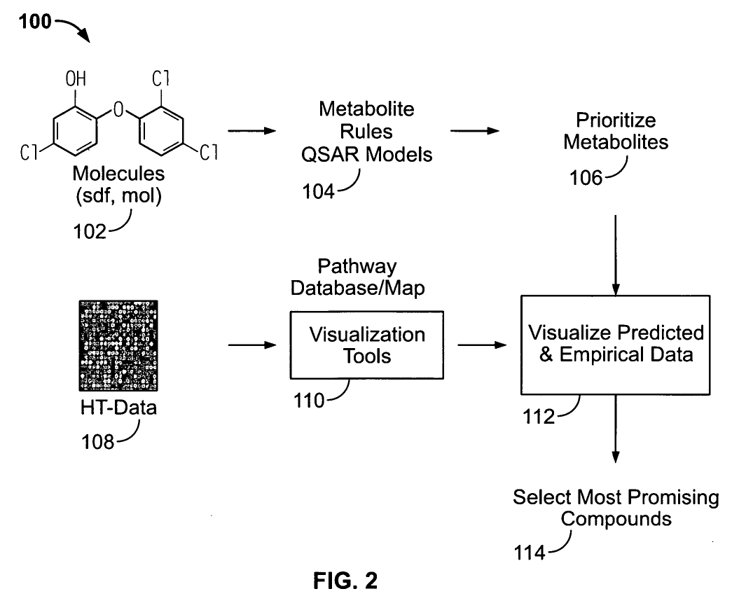

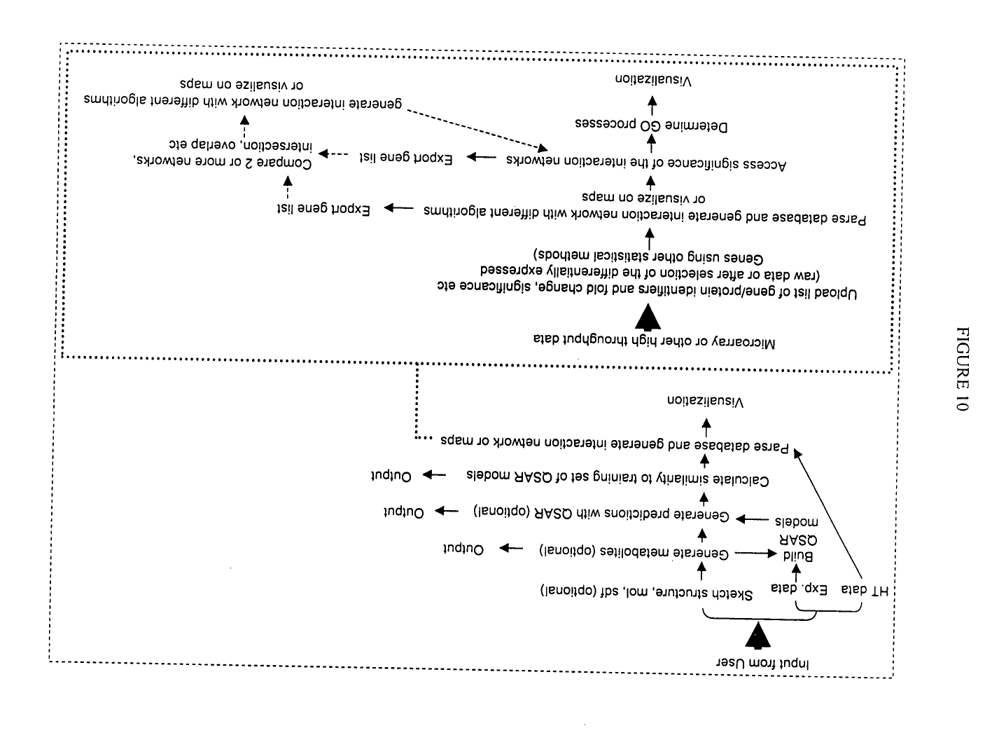

FIG. 2 shows an example of a workflow path (item 100) in a drug discovery system; FIG. 10 is a more detailed example of the same workflow path. The following example is merely an illustrative embodiment of a flow path for a drug discovery system. It should be appreciated that an illustrative embodiment is not intended to limit the scope of the invention, as any of numerous other implementations of a drug discovery system, for example, variations on steps taken, are possible and are intended to fall within the scope of the invention. For a drug discovery system of the invention, additional steps may be used or one or more steps may be removed from the example. Additionally, steps may be reversed or performed in a different order. None of the claims set forth below are intended to be limited to any particular implementation of the database structure unless such claim includes a limitation explicitly reciting a particular implementation.

In FIG. 2, a scientist inputs the chemical that he or she wants to process through the drug discovery system using a user interface at step 102. The chemical may be input as a name or a structure. The name may be input by text using any chemical identification system, including CAS number, standard chemical nomenclature, common chemical nomenclature, or a custom nomenclature system. If only a chemical identifier is entered into the system, a two-dimensional or three-dimensional chemical structure may be determined using predetermined rules (that may be able to be revised by the scientist) or by accessing a database(s) of chemical structures.

The chemical may also be input using a chemical structure format including sdf and mol files or through a structure drawing program such as ChemDraw (CambridgeSoft Corporation, Cambridge, Mass.). If only the chemical structure is input, the drug discovery software may determine or assign a chemical identifier to the molecule.

A scientist may interact with the drug discovery system using wireless or line telephone with display, handheld device, kiosk, or computer. For example, a scientist may operate a computer system that has an Internet-enabled interface (e.g., using Macromedia Flash or Java) and the computer system may display streamed information within that interface. It should be appreciated that any interface may be used to interact with the drug discovery system and that the invention is not limited to any particular interface. Depending upon the medium used for interaction with the drug discovery system, it may be necessary to download information or executable subprograms prior to interacting with the drug discovery system while another medium may allow continuous interaction with the drug discovery system without such downloads.

As used herein, a “database” is an arrangement of data defined by computer-readable signals. These signals may be read by a computer system, stored on a medium associated with a computer system (e.g., in a memory, on a disk, etc.) and may be transmitted to one or more other computer systems over a communications medium such as, for example, a network. Also as used herein, a “user interface” or “UI” is an interface between a human user and a computer that enables communication between a user and a computer. Examples of UIs that may be implemented with various aspects of the invention include a graphical user interface (GUI), a display screen, a mouse, a keyboard, a keypad, a track ball, a microphone (e.g., to be used in conjunction with a voice recognition system), a speaker, a touch screen, a specialized controller (e.g., a joystick), a track pad, etc., and any combinations thereof.

At step 104, the input molecule is then processed through the drug discovery system using predetermined rules or QSAR models to predict the first-level metabolites of the chemical. Examples of some of the predetermined rules or QSAR models are given in Table 2. At step 104, the drug discovery system may also provide a statistical probability that each predicted metabolite will occur. At step 104, there may be a number of readily interpretable molecular descriptors that are calculated for the input molecule such as the number of rotatable bonds, hydrogen bond acceptors and hydrogen bond donors. The input molecule may also be processed through rules developed specifically to predict likely reactive metabolites (such as quinones, aromatic and hydroxyl amines, acyl glucuronides, acyl halides, epoxides, thiophenes, furans, phenoxyl radicals, phenols and aniline radicals) and readily highlight these for the user. At step 104, the predicted QSAR values can be filtered with user defined cutoff values; these values may also be used to prioritize metabolites.

At step 106, the drug discovery system or the scientist may then determine which metabolites to continue to process through the drug discovery system. The determination of which metabolites to continue processing may be based upon the statistical probability mentioned above, on instinct, on experimental data, or on any other criteria. The metabolites still remaining after stop 106 may then each be run back through steps 104 and 106. Steps 104 and 106 may occur as many times as desired; more iterations of steps 104 and 106 predict higher and higher-level metabolites.

TABLE 2
Examples of Metabolite Transformation Rules

| Type | Associated Metabolic Rules |
|---|---|
| C oxidation | N-dealkylation, O-dealkylation, Aromatic hydroxylation, |
| | Aliphatic hydroxylation, Double bond peroxidation, |
| | Hydroxyl-carbonyl oxidation, Double bond formation |
| | (desaturation), Aldehyde oxidation, Thione oxidation, |
| | Alcohol oxidation, Double bond epoxidation, Oxidative |
| | dehalogenation, Morpholine oxidative cleavage, |
| | Morpholine cleavage, Oxidative deboronation, Oxidative |
| | amine deboronation, Methylketone oxidation, Thiophene |
| | C-oxidation, Aromatic bond epoxidation, Aromatic bond |
| | oxidation, Primary alcohol oxidation |
| Quinone formation | o-quinone formation, p-quinone formation, Complex |
| | quinone formation |
| N oxidation | N-oxide formation, N-hydroxylation, NH₂ oxidation, |
| | Oxime oxidation, Tertiary amine desaturation |
| S oxidation | S-dealkylation, Thiophene oxidation, Isothiazole S- |
| | oxidation, Isothiazole N,S-oxidation |
| S═O formation | Thiol oxidation, Sulfide oxidation, Sulfoxide oxidation |
| P oxidation | Phosphorothioate to phosphate, Phosphite oxidation |
| Reduction | Azide reduction, Azo reduction, Carbonyl reduction, |
| | Nitro-group reduction, Sulfoxide reduction, Carboxyl |
| | reduction, Hemiacetal reduction, Isothiazole cleavage |
| Hydrolysis | Ester hydrolysis, Epoxide hydrolysis, Amide hydrolysis, |
| | Phosphate hydrolysis, Phosphite hydrolysis |
| Glucuronidation | N-glucuronide transfer, O-glucuronide transfer, S- |
| | glucuronide transfer |
| Sulfation | O-sulfate transfer, N-sulfate transfer |
| Glutathione conjugation | S-glutathione transfer, Glutathione S-transfer to epoxide, |
| | Glutathione S-transfer - halogen, Glutathione S-transfer |
| | to alkenes, Glutathione transfer to aldehyde, Glutathione |
| | replacement of sulfate, Glutathione S-transfer to |
| | quinines, Glutathione S-transfer to benzyl, Glutathione |
| | S-transfer to nitroarenes |
| Methyl transferases | O-methyl transfer, N-methyl transfer, S-methyl transfer, |
| | Heterocyclic N-methyl transfer |
| Cysteine conjugation | Cysteine S-transfer to epoxide, Cysteine S-transfer - |
| | halogen, Cysteine S-transfer to alkenes, Cysteine transfer |
| | to aldehyde, Cysteine replacement of sulfate, Cysteine S- |
| | transfer to benzyl, Cysteine transfer to Cys |
| N-formyl transfer | N-formyl transfer |
| O-phosphate transfer | O-phosphate transfer |
| Glycine conjugation | Glycine conjugation |
| Glutamine conjugation | Glutamine conjugation |
| N-acetyl transfer | N-acetyl transfer |
| Spontaneous | Ketone tautomerization, Vicdiol to aldehyde |

At step 112, the drug discovery system processes the initial chemical and all the predicted metabolites left in the model and predicts the total effect of the initial chemical on the biological organism (e.g., homo sapiens) being studied. The total effect is determined after considering protein pathways, gene regulation, enzyme regulation or any biological interaction. The drug discovery system may automatically determine which interactions to consider or a scientist may make choices.

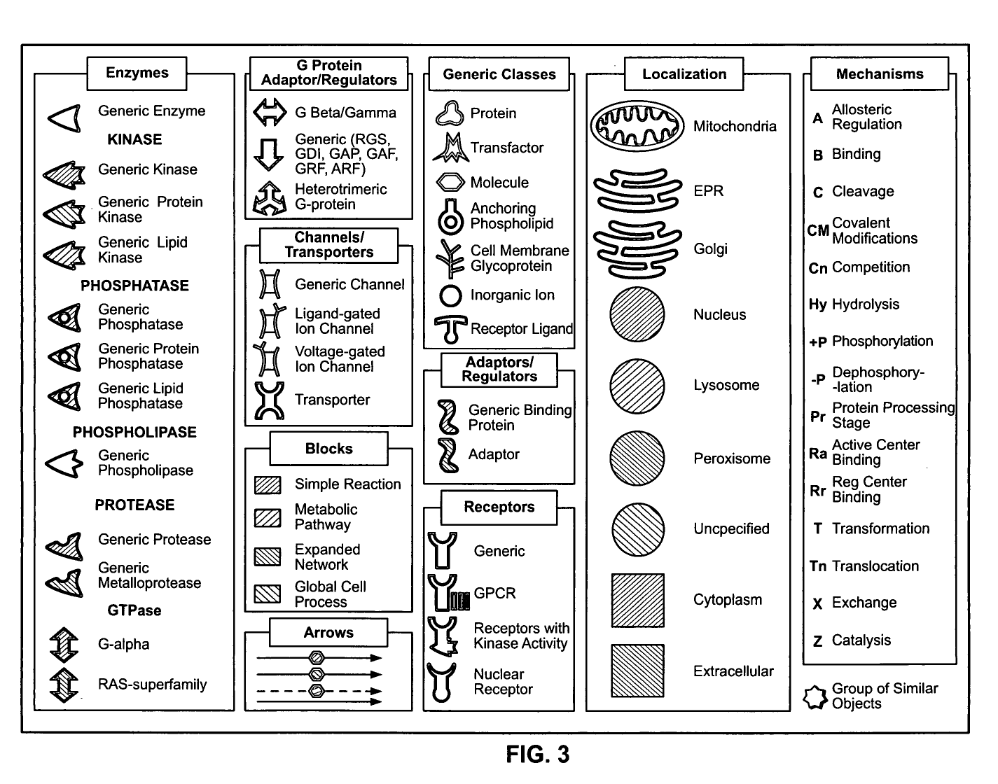

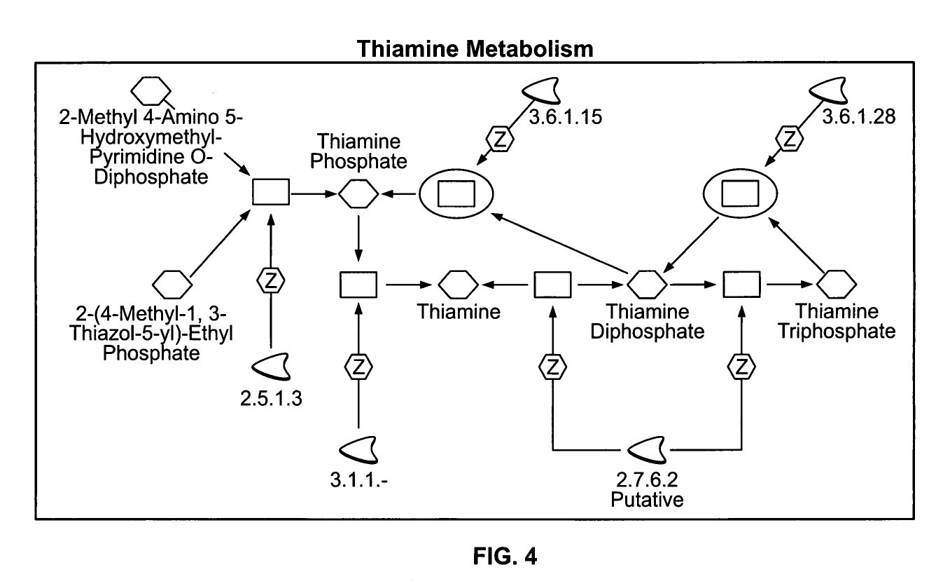

At step 112, the drug discovery system may also graphically represent the effect of the chemical and its metabolites on the biological organism. Due to the complexity of biological organisms, a legend may be necessary to differentiate the various elements of the map; FIG. 3 is a representation of a legend. The legend may use any combination of text, color, shape, and overlays to represent any or all elements in the biological map. With such a legend, the interaction map becomes easier to understand as represented in FIG. 4 for thiamine metabolism. The interaction map shown in FIG. 4 has only a few levels of metabolites in the evaluation and shows only two metabolic pathways to thiamine; the map may become much more complex, including with the addition of any of the following: thiamine breakdown, thiamine effect on biological organism regulation, thiamine metabolites, and thiamine metabolite interaction with the biological organism.

At step 112, the drug discovery system may also provide the input chemical, its predicted metabolites, statistics, and any other information as text, a worksheet (e.g., for Microsoft Excel), or as a new database to the user.

In FIG. 2, the drug discovery system may also process OMICs or high throughput data. In step 108, HT data is processed and in step 110 developed into a new biological pathway after analysis. Using the visualization methods described above, the new biological pathway may also be graphically or textually represented. The HT data may be from actual biological studies of the chemical of interest in the specified or another biological organism or may be of any related or non-related chemical.

With the HT data analysis, step 112 can also be used to compare the predicted metabolic pathway for the molecule input in step 102 with the actual data generated in step 108.

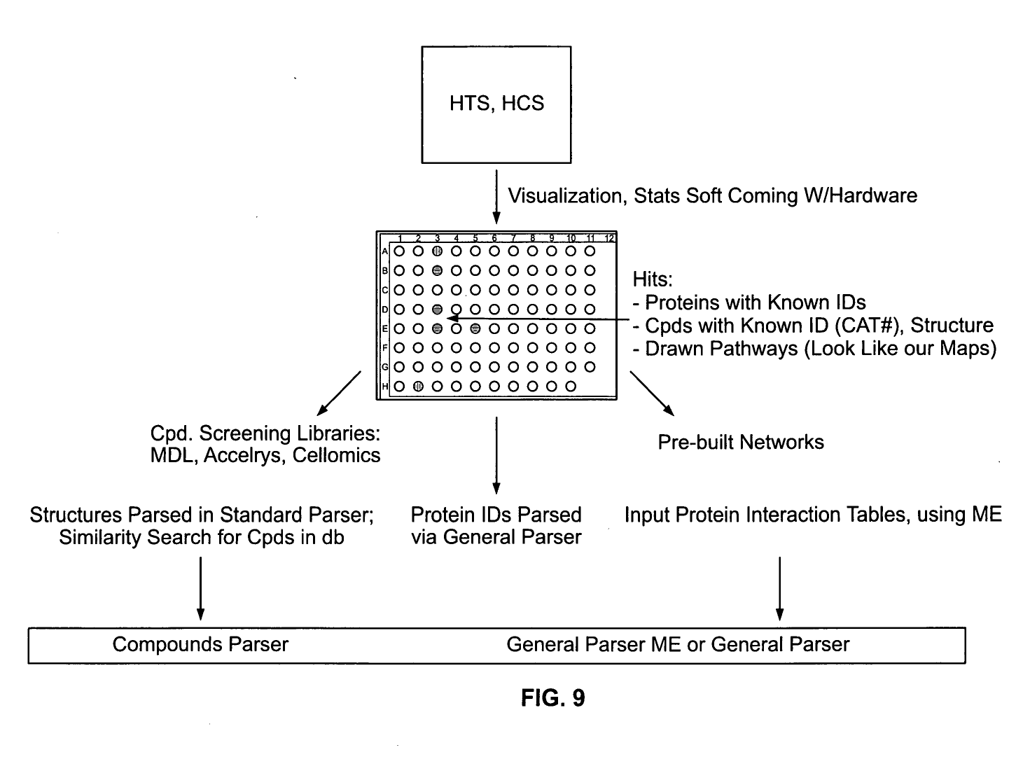

FIG. 9 is a high level representation of a system for high-throughput screening for functional analysis of compound screening data. The data from both high-content screening (HCS) and high-throughput screening (HTS) assays may be analyzed using a chemical similarity search. Once similar chemicals are identified, two information sets are generated. The first dataset is based upon the known networks and information of the similar chemicals; such information may include maps of biological pathways, functional processes, diseases, toxicities, and biological networks. The second dataset is based upon the predicted metabolites of the compound being screened. All the information from both datasets are then analyzed to refine the predicted biological pathways, functional processes, diseases, toxicities, and biological networks of the screened compound.

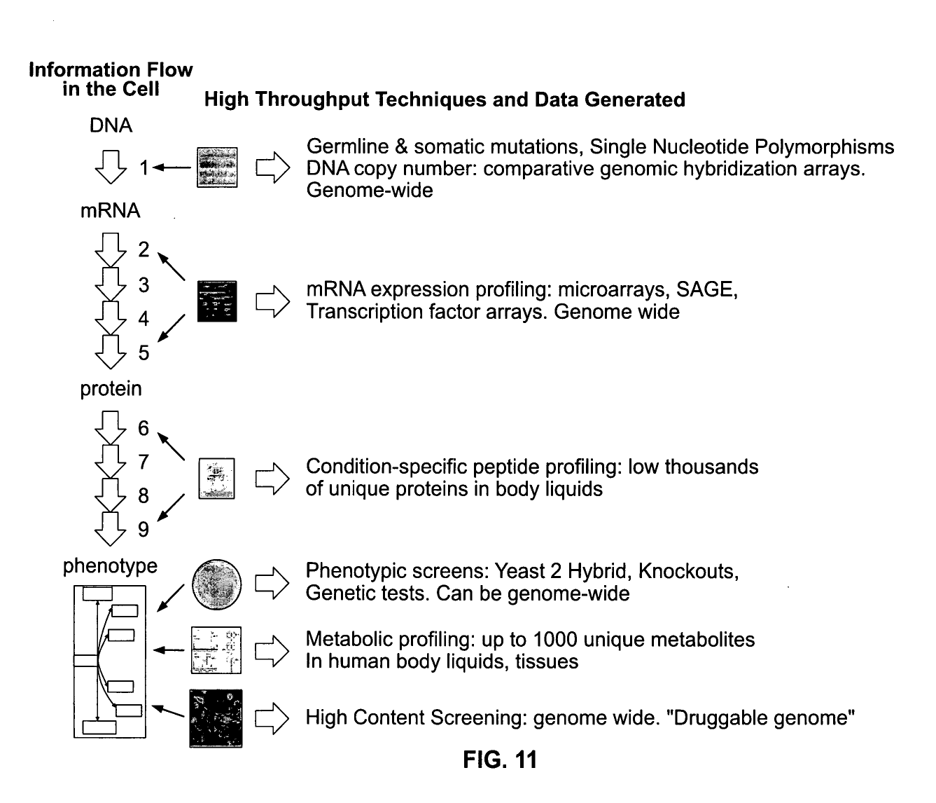

FIG. 11 represents the different data types that are generated in a cell, the interaction of the various data types, and the high-throughput technique that may be used to obtain the data. Various high-throughput or high content data can be linked to tables of human protein interactions. Nine levels of regulation of protein activity in a human cell can be summarized: 1) gene transcription, 2) mRNA processing and editing, 3) mRNA transport from nucleus, 4) mRNA stabilization, 5) protein translation, 6) protein transport, 7) folding and protein stabilization, 8) allosteric modulation, and 9) covalent modification. The types of data generated corresponding to these levels are also shown.

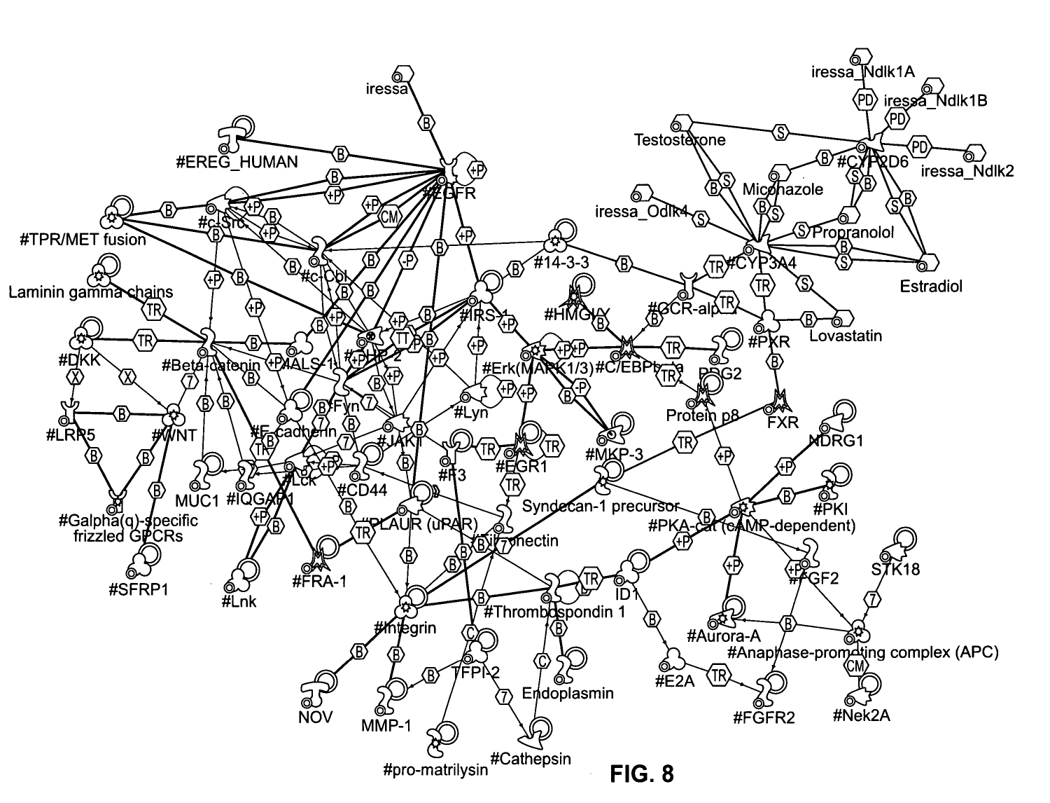

A predicted biological network for Iressa, an anti-cancer drug is represented in FIG. 8; the biological network shows both predicted metabolites and the mode of action. This assessment is produced by analysis of microarray expression data in mice model and also using the metabolic rules in the drug discovery system of this invention. The drug is predicted to inhibit EGFR as its primary target; microarray data confirms this. One can see down-regulation of downstream proteins, including the WNT pathway (marked with blue circles). Pink hexagons mark the predicted human metabolites of Iressa. The metabolites are linked to phase I drug metabolizing enzymes CYP3A4 and CYP2D6, and via nuclear hormone receptor PXR to GCR receptor and the upstream signaling cascades—all on one network.

After evaluation of the results from step 112, the computer or the scientist may then select the most promising chemical compounds that affects or regulates the biological organism as desired. With the appropriate parameters on the biological map, the promising chemical compounds may be also be chosen that create the lowest amount of side or deleterious effects.

A drug discovery system may have any combination (including a few, some, many, or all) of the following features.

A set of databases, possibly having an Oracle-based architecture;
At least one or more databases;
At least one database of proprietary, manually curated mammalian data Greater than 10,000 compounds, preferably greater than 15,000 compounds, more preferably greater than 20,000 compounds;
Greater than one thousand, preferably greater than 2,000, more preferably greater than 3,000 marketed drugs, possibly with associated binding information;
Greater than 1,000, preferably greater than 2,000, more preferably greater than 4,000 xenobiotics;
Greater than 1,000, preferably greater than 2,500, more preferably greater than 5,000 endogenous metabolites;
Greater than 1,000, preferably greater than 2,000, more preferably greater than 3,000 binding constants for CYPs, UGTS, SULTs, and other important human enzymes;
Greater than 1,000, preferably greater than 5,000, more preferably greater than 10,000 xenobiotic reactions;
Greater than 10,000, preferably greater than 20,000, more preferably greater than 30,000 unique article references from greater than 1,000 sources;
Greater than 100, preferably greater than 200, more preferably greater than 400 metabolism and signaling maps;
Greater than 25,000 human genes;
Greater than 15,000 mouse orthologs;
Greater than 10,000 rat orthologs;
Greater than 2,500, preferably greater than 5,000, more preferably greater than 10,000 human proteins;
Greater than 2,500, preferably greater than 5,000, more preferably greater than 7,500 human proteins on maps and networks;
Greater than 10,000, preferably greater than 20,000, more preferably greater than 30,000 curated pathways;

Software tools;
Algorithm rule based prediction of metabolites using greater than 25, preferably greater than 50, more preferably greater than 85 rules;
Algorithm for allowing sequential metabolism of a molecule and its metabolites in one process.
Algorithm for prioritizing metabolites based on similarity to published molecules in our or other databases of drug metabolism data.
Algorithm for highlighting likely reactive metabolites using greater than 25, preferably greater than 50, more preferably greater than 90 rules;
Algorithm for determining metabolite occurrence ratio to prioritize metabolites;
Greater than 40 QSAR models for CYP binding and ADME/Tox properties using recursive partitioning and 2D descriptors;
Ability to allow the user to use their own data for building QSAR models which are then incorporated in the software.
At least one model that determines standard deviations;
Chemical structures may be input using sdf and mol files;
Large files may be processed in batch mode;
PipelinePilot (Scitegic, San Diego, Calif.) may be used with MetaDrug modules to create work flows for batch processing and integration with other informatics software.
ChemDraw or other plug-in or molecular drawing device may be used for structure visualization;
Parsers may be used for genomics, proteomics, metabolomics or other experimental or theoretical data;
Concurrent visualization of genomics, proteomics, metabolomics or other experimental or theoretical data on objects from database;
Networks that interact with desired chemical compounds or metabolites may be built as needed;
At least two algorithms for network building;
Substructure, structure, and similarity searching of databases, that may use the Accord plug-in;
Grid or other types of visualization of multiple metabolites and predicted or empirical data points;
Export of predicted metabolites as well as predicted scores and properties as an sdf, text, Microsoft Excel file or other file format;
Apex (Sierra Analytics, Modesto, Calif.) may be used with sdf files output from MetaDrug to enable comparison of predicted metabolites with empirical metabolite data derived from mass spectra or MS/MS.
Simple molecular descriptor generation (molecular weight, rotatable bonds, number of hydrogen bond acceptors, and number of hydrogen bond donors or other descriptors), that may use the Accord or other plug-in for molecular descriptor calculation;
Threshold capability to filter predicted metabolites;
Color or other methods for highlighting of predicted properties;
Data mining capability using the underlying database to search by gene, molecule, etc., to build networks containing enzymes, regulators, and molecules;
Drug target information assigning known molecules to proteins;
Software to visualize predicted metabolites on gene interaction networks alongside empirical data from the database as well as experimental high throughput data;
Greater than 1,000, preferably greater than 2,000, more preferably greater than 3,000 disease links to genes;
Links to other databases, such as OMIM, GenBank, SwissProt, SNPs;
Options to filter by orthologs, tissues, diseases, etc.; and
Flexible architecture to incorporate various QSAR or other software algorithm types.

The drug discovery system, and components thereof such as the databases and software tools, may be implemented using software (e.g., C, C#, C++, Java, or a combination thereof), hardware (e.g., one or more application-specific integrated circuits), firmware (e.g., electronically programmed memory), or any combination thereof. One or more of the components of the drug discovery system may reside on a single computer system (e.g., the data mining subsystem), or one or more components may reside on separate, discrete computer systems. Further, each component may be distributed across multiple computer systems, and one or more of the computer systems may be interconnected.

Further, on each of the one or more computer systems that include one or more components of the drug discovery system, each of the components may reside in one or more locations on the computer system. For example, different portions of the components of the drug discovery system may reside in different areas of memory (e.g., RAM, ROM, disk, etc.) on the computer system. Each of such one or more computer systems may include, among other components, a plurality of known components such as one or more processors, a memory system, a disk storage system, one or more network interfaces, and one or more busses or other internal communication links interconnecting the various components.

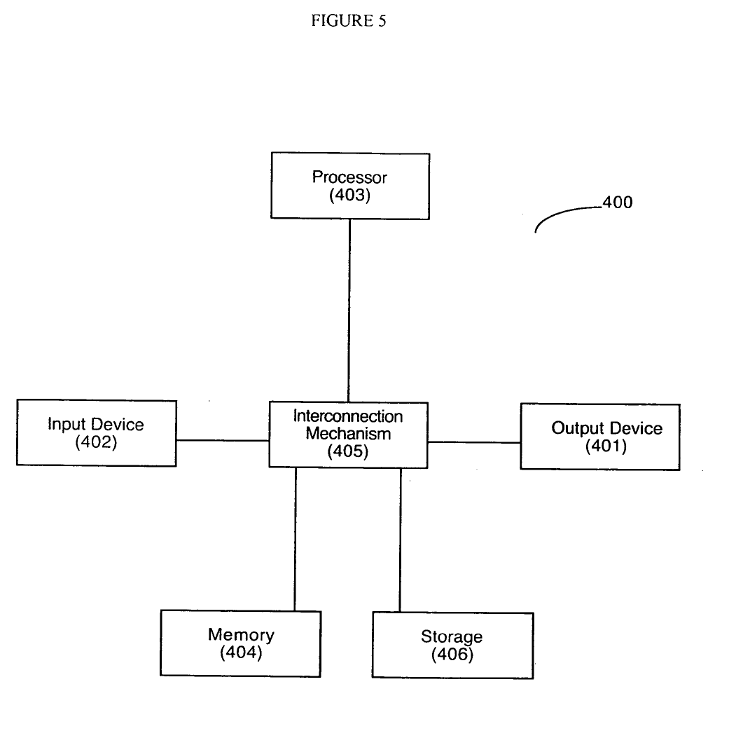

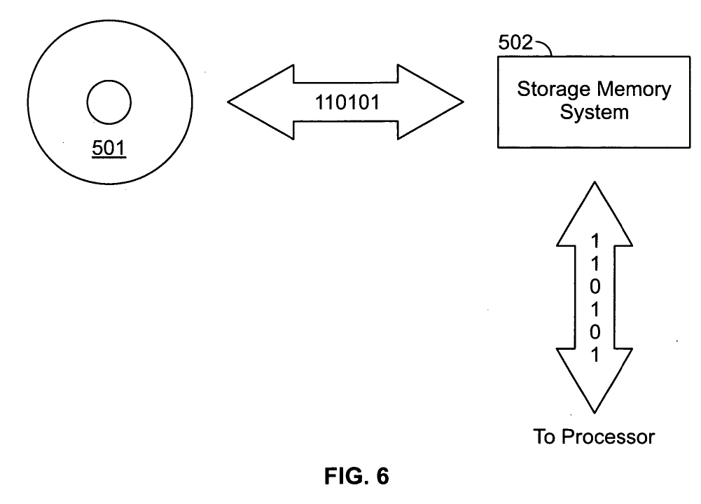

The drug discovery system may be implemented on a computer system described below in relation to FIGS. 5 and 6.

The drug discovery system described above is merely an illustrative embodiment of a drug discovery system. Such an illustrative embodiment is not intended to limit the scope of the invention, as any of numerous other implementations of a drug discovery system, for example, variations of the databases contained within, are possible and are intended to fall within the scope of the invention. None of the claims set forth below are intended to be limited to any particular implementation of the drug discovery system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

A general-purpose computer system according to one embodiment of the invention is configured to perform any of the described drug discovery system functions. It should be appreciated that the system may perform other functions, including network communication, and the invention is not limited to having any particular function or set of functions.

For example, various aspects of the invention may be implemented as specialized software executing in a general-purpose computer system 400 such as that shown in FIG. 5. The computer system 400 may include a processor 403 connected to one or more memory devices 404, such as a disk drive, memory, or other device for storing data. Memory 404 is typically used for storing programs and data during operation of the computer system 400. Components of computer system 400 may be coupled by an interconnection mechanism 405, which may include one or more busses (e.g., between components that are integrated within a same machine) and/or a network (e.g., between components that reside on separate discrete machines). The interconnection mechanism 405 enables communications (e.g., data, instructions) to be exchanged between system components of system 400. Computer system 400 also includes one or more input devices 402, for example, a keyboard, mouse, trackball, microphone, touch screen, and one or more output devices 401, for example, a printing device, display screen, speaker. In addition, computer system 400 may contain one or more interfaces (not shown) that connect computer system 400 to a communication network (in addition or as an alternative to the interconnection mechanism 405.

The storage system 406, shown in greater detail in FIG. 6, typically includes a computer readable and writeable nonvolatile recording medium 501 in which signals are stored that define a program to be executed by the processor or information stored on or in the medium 501 to be processed by the program. The medium may, for example, be a disk or flash memory. Typically, in operation, the processor causes data to be read from the nonvolatile recording medium 501 into another memory 502 that allows for faster access to the information by the processor than does the medium 501. This memory 502 is typically a volatile, random access memory such as a dynamic random access memory (DRAM) or static memory (SRAM). It may be located in storage system 406, as shown, or in memory system 404, not shown. The processor 403 generally manipulates the data within the integrated circuit memory 404, 502 and then copies the data to the medium 501 after processing is completed. A variety of mechanisms are known for managing data movement between the medium 501 and the integrated circuit memory element 404, 502, and the invention is not limited thereto. The invention is not limited to a particular memory system 404 or storage system 406.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 400 is shown by way of example as one type of computer system upon which various aspects of the invention may be practiced, it should be appreciated that aspects of the invention are not limited to being implemented on the computer system as shown in FIG. 5. Various aspects of the invention may be practiced on one or more computers having a different architecture or components than that shown in FIG. 5.

Computer system 400 may be a general-purpose computer system that is programmable using a high-level computer programming language. Computer system 400 may be also implemented using specially programmed, special purpose hardware. In computer system 400, processor 403 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL), or interpreted (e.g., Java) code that communicates over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “containing”, “characterized by” and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition 2^{nd} Revision, May 2004), Section 2111.03.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for predicting the interaction between a chemical compound and a biological organism, the system comprising:
a first means for predicting one or more first level metabolites of the chemical compound in the biological organism;
a second means for predicting the interaction of the chemical compound and the first level metabolites with the biological organism; and
a means for visualizing the interaction of the chemical compound, the first level metabolites, and the biological organism.

2. A system according to claim 1, wherein the biological organism is a human being.

3. A system according to claim 1, wherein the biological organism is modeled using one or more types of biological compounds.

4. A system according to claim 3, wherein the one or more types of biological compounds is comprised of one or more of the group composed of proteins, nucleic acids, or organic compounds.

5. A system according to claim 4, wherein the group of proteins is comprised of one or more of the group composed of enzymes, prions, and peptides.

6. A system according to claim 4, wherein nucleic acids is comprised of one or more of the group composed of DNA, RNA, genes, and chromosomes.

7. A system according to claim 1, further comprising a third means for predicting one or more higher-level metabolites of the one or more first level metabolites.

8. A system according to claim 7, wherein the third means is the same as the first means.

9. A system according to claim 1, further comprising means for inputting one of the chemical compound name, structure, or data.

10. A system according to claim 7, further comprising a fourth means for prediction of the likelihood of the one or more predicted first level or higher-level metabolites to occur in the biological organism.

11. A system according to claim 7, further comprising means for choosing the one or more predicted first level or higher-level metabolites to predict the interactions of the chemical compound in the biological organism.

12. A system according to claim 1, further comprising means for analyzing high-throughput data.

13. A system according to claim 12, further comprising means for generating one or more biological pathways from the high-throughput data.

14. A system according to claim 1, further comprising databases comprising of at least one or more of the group composed of xenobiotics, endobiotics, ligands, drugs, drug interactions, drug binding data, biological pathways, genes, proteins, and disease links to genes.

15. A system according to claim 7, further comprising means for comparing predicted interactions of at least one of the chemical compound, first level metabolites and higher-level metabolites in the biological organism with the biological pathways generated from the high-throughput data.

16. A system according to claim 7, wherein the predicted interaction of at least one of the chemical compound, first level metabolites, and higher-level metabolites with the biological organism is advantageous.

17. A system according to claim 16, wherein the advantageous interaction predicts the chemical compound can be used as a drug in the biological organism.

18. A system according to claim 7, wherein the predicted interaction of at least one of the chemical compound, first level metabolites, and higher-level metabolites with the biological organism is disadvantageous.

19. A system according to claim 18, wherein the disadvantageous interaction predicts the chemical compound is toxic or has side or deleterious effects in the biological organism.

20. A system according to claim 7, wherein the one or more first level or higher-level metabolites of the chemical compound are predicted using predetermined rules, QSAR models, or other algorithms.

21. A system according to claim 20, wherein a system user may choose the predetermined rules, QSAR models, or other algorithms to predict the one or more first level or higher-level metabolites of the chemical compound.

22. A method for predicting the interaction between a chemical compound and a biological organism, the method comprising of the steps of:
a) predicting one or more first level metabolites of the chemical compound in the biological organism;
b) predicting the interaction of the chemical compound and the first level metabolites with the biological organism; and
c) visualizing the interaction of the chemical compound, the first level metabolites, and the biological organism.

23. A method according to claim 22, wherein the biological organism is a human being.

24. A method according to claim 22, wherein the biological organism is modeled using one or more types of biological compounds.

25. A method according to claim 24, wherein the one or more types of biological compounds is comprised of one or more of the group composed of proteins, nucleic acids, or organic compounds.

26. A method according to claim 25, wherein the group of proteins is comprised of one or more of the group composed of enzymes, prions, and peptides.

27. A method according to claim 25, wherein nucleic acids is comprised of one or more of the group composed of DNA, RNA, genes, and chromosomes.

28. A method according to claim 22, further comprising additional step
d) predicting one or more higher-level metabolites of the one or more first level metabolites.

29. A method according to claim 28, wherein step d is accomplished using the same means as step a.

30. A method according to claim 22, further comprising step
e) inputting one of the chemical compound name, structure, or data.

31. A method according to claim 29, further comprising step
f) predicting of the likelihood of the one or more predicted first level or higher-level metabolites to occur in the biological organism.

32. A method according to claim 29, further comprising step
g) choosing the one or more predicted first level or higher-level metabolites to predict the interactions of the chemical compound in the biological organism.

33. A method according to claim 22, further comprising step
h) analyzing high-throughput data.

34. A method according to claim 33, further comprising step
i) generating one or more biological pathways from the high-throughput data.

35. A method according to claim 22, further comprising databases comprising of at least one or more of the group composed of xenobiotics, endobiotics, ligands, drugs, drug interactions, drug binding data, biological pathways, genes, proteins, and disease links to genes.

36. A method according to claim 28, further comprising step
j) comparing predicted interactions of at least one of the chemical compound, first level metabolites and higher-level metabolites in the biological organism with the biological pathways generated from the high-throughput data.

37. A method according to claim 28, wherein the predicted interaction of at least one of the chemical compound, first level metabolites, and higher-level metabolites with the biological organism is advantageous.

38. A method according to claim 37, wherein the advantageous interaction predicts the chemical compound can be used as a drug in the biological organism.

39. A method according to claim 28, wherein the predicted interaction of at least one of the chemical compound, first level metabolites, and higher-level metabolites with the biological organism is disadvantageous.

40. A method according to claim 39, wherein the disadvantageous interaction predicts the chemical compound is toxic or has side or deleterious effects in the biological organism.

41. A method according to claim 28, wherein the one or more first level or higher-level metabolites of the chemical compound are predicted using predetermined rules, QSAR models, or other algorithms.

42. A method according to claim 41, wherein a system user may choose the predetermined rules, QSAR models, or other algorithms to predict the one or more first level or higher-level metabolites of the chemical compound.

43. A computer means for predicting the interaction between a chemical compound and a biological organism, the computer means comprising:
a first means for predicting one or more first level metabolites of the chemical compound in the biological organism;
a second means for predicting the interaction of the chemical compound and the first level metabolites with the biological organism; and
a means for visualizing the interaction of the chemical compound, the first level metabolites, and the biological organism.

44. A computer means according to claim 43, wherein the biological organism is a human being.

45. A computer means according to claim 43, wherein the biological organism is modeled using one or more types of biological compounds.

46. A computer means according to claim 45, wherein the one or more types of biological compounds is comprised of one or more of the group composed of proteins, nucleic acids, or organic compounds.

47. A computer means according to claim 46, wherein the group of proteins is comprised of one or more of the group composed of enzymes, prions, and peptides.

48. A computer means according to claim 46, wherein nucleic acids is comprised of one or more of the group composed of DNA, RNA, genes, and chromosomes.

49. A computer means according to claim 43, further comprising a third means for predicting one or more higher-level metabolites of the one or more first level metabolites.

50. A computer means according to claim 49, wherein the third means is the same as the first means.

51. A computer means according to claim 43, further comprising means for inputting one of the chemical compound name, structure, or data.

52. A computer means according to claim 49, further comprising a fourth means for prediction of the likelihood of the one or more predicted first level or higher-level metabolites to occur in the biological organism.

53. A computer means according to claim 49, further comprising means for choosing the one or more predicted first level or higher-level metabolites to predict the interactions of the chemical compound in the biological organism.

54. A computer means according to claim 43, further comprising means for analyzing high-throughput data.

55. A computer means according to claim 54, further comprising means for generating one or more biological pathways from the high-throughput data.

56. A computer means according to claim 43, further comprising databases comprising of at least one or more of the group composed of xenobiotics, endobiotics, ligands, drugs, drug interactions, drug binding data, biological pathways, genes, proteins, and disease links to genes.

57. A computer means according to claim 49, further comprising means for comparing predicted interactions of at least one of the chemical compound, first level metabolites and higher-level metabolites in the biological organism with the biological pathways generated from the high-throughput data.

58. A computer means according to claim 49, wherein the predicted interaction of at least one of the chemical compound, first level metabolites, and higher-level metabolites with the biological organism is advantageous.

59. A computer means according to claim 58, wherein the advantageous interaction predicts the chemical compound can be used as a drug in the biological organism.

60. A computer means according to claim 49, wherein the predicted interaction of at least one of the chemical compound, first level metabolites, and higher-level metabolites with the biological organism is disadvantageous.

61. A computer means according to claim 60, wherein the disadvantageous interaction predicts the chemical compound is toxic or has side or deleterious effects in the biological organism.

62. A computer means according to claim 49, wherein the one or more first level or higher-level metabolites of the chemical compound are predicted using predetermined rules, QSAR models, or other algorithms.

63. A computer means according to claim 62, wherein a system user may choose the predetermined rules, QSAR models, or other algorithms to predict the one or more first level or higher-level metabolites of the chemical compound.
